(19) United States
(12) Patent Application Publication
(10) Pub. No.: US 2019/0148028 A1
(43) Pub. Date: May 16, 2019

(54) REFLECTOR

(71) Applicant: Oxford University Innovation Limited, Oxford (GB)

(72) Inventors: Sean Robert Ravenhall, Oxford (GB); Christopher John Foot, Oxford (GB)

(21) Appl. No.: 16/098,049

(22) PCT Filed: Apr. 28, 2017
(86) PCT No.: PCT/GB2017/051194

§ 371 Date: Oct. 31, 2018

(30) Foreign Application Priority Data
May 3, 2016 (GB) 1607686.1

(51) Int. Cl. G21K 1/06

(52) U.S. Cl. CPC G21K 1/06; G21K 2201/068; G21K 2201/065

(57) ABSTRACT

A reflector (15) for cooling or trapping atoms or molecules, the reflector (15) having a reflecting surface (17) forming a perimeter around and facing a central axis (33), the reflecting surface (17) extending along the axis (33), and converging from a first end of the reflector (15) towards a second end of the reflector (15), such that the reflecting surface (17) is arranged to reflect input laser light to form a cooling region (21), wherein an aperture (23) for providing a beam (27) of cooled atoms or molecules from the cooling region (21) is formed in the reflecting surface (17), the aperture (23) perpendicular to the central axis (33), such that the reflector (15) forms a truncated pyramid, and wherein the reflecting surface (17) is formed by three or more planar mirrors (39a-d) arranged around and at an angle to the central axis (33).

The present invention relates to a reflector for laser cooling or trapping atoms or molecules. In particular, but not exclusively, the present invention relates to a reflector for use in a magneto-optical trap that produces a beam of cold atoms or molecules.

Beams of cold atoms have a range of different applications. One technique that can be used to produce a beam of cold atoms is to laser cool the atoms in a magneto-optical trap.

The temperature of atoms is related to their kinetic energy, which depends on how fast the atoms move. In laser cooling and trapping, lasers are used to generate a force on atoms, in order to slow the atoms down. Typically, to cool and trap atoms in three dimensions, six separate laser beams are required in a spatially varying magnetic field. The laser beams are directed towards a trapping region formed where the magnetic field is zero. The laser beams are arranged in opposing pairs around the trapping region, with each pair incident along a different perpendicular axis. In other examples, four laser beams arranged in a tetrahedral geometry may be used, or other arrangements of beams may be used. Recently, molecules have also been trapped using similar techniques.

In order to cool and trap atoms or molecules, it is necessary to operate under high vacuum. Typically, high vacuum is defined as pressures below 10⁻⁴ Pascals. For large volumes, it can take several days to pump down to this pressure.

“A pyramidal magneto-optical trap as a source of slow atoms”, J. J. Arlt et al, Optics Communications 157 (1998) 303-309 discloses a magneto-optical trap that uses a pyramidal reflector. The reflector is formed by a pair of prisms and a pair of square mirrors, and is used to reflect a single input laser to generate the six beams required. An aperture is provided at the apex of the pyramid, through which a beam of cooled atoms is provided.

The pyramidal reflector is complex to manufacture due to the different mirrors. Also, separate reflectors are required when different size apertures are required. Furthermore, in order to change the reflector, the high vacuum environment must be broken and re-pumped.

According to a first aspect of the invention, there is provided a reflector for cooling and/or trapping atoms or molecules, the reflector having a reflecting surface forming a perimeter around and facing a central axis, the reflecting surface extending along the axis, and converging from a first end of the reflector towards a second end of the reflector, such that the reflecting surface is arranged to reflect input laser light to form a cooling region. An aperture for providing a beam of cooled atoms or molecules from the cooling region is formed in the reflecting surface, the aperture perpendicular to the central axis, such that the reflector forms a truncated pyramid. The reflecting surface may be formed by three or more planar mirrors arranged around and at an angle to the central axis.

Planar mirrors are simple to manufacture, making the reflector simple to manufacture. Furthermore, the arrangement of planar mirrors is simple to reconfigure to alter the size of the aperture, and the use of planar mirrors makes the reflector scalable. A reflector formed of planar mirrors is also compact, such that it can fit inside small spaces, which reduces costs when operating under high vacuum since a small volume is more efficient to pump down to high vacuum than a larger volume.

Each planar mirror may form a portion of the perimeter around the central axis. A first portion of a first planar mirror may overlie a portion of a second planar mirror, the second planar mirror adjacent a first side of the first planar mirror.

A second portion of the first planar mirror may underlie a portion of a further planar mirror, the further planar mirror adjacent a second side of the first planar mirror, opposite the first side.

A side of a planar mirror overlying an adjacent planar mirror may be chamfered, such that the reflecting surface of the mirror is wider than an opposing rear surface.

The planar mirrors may be formed from a portion of a circle.

The planar mirrors may have a curved edge arranged to be positioned at the first end of the reflector, a straight edge, arranged to be positioned at the second end of the reflector, forming an edge of the aperture, a first side extending from a first end of the curved edge, to a first end of the straight edge, and a second side extending from a second end of the curved edge, to a second end of the straight edge.

The first side may extend obliquely to the straight edge.

The second side may extend perpendicularly to the straight edge.

Each of the planar mirrors may have the same shape.

Preferably, the reflecting surface is formed by four planar mirrors.

The planar mirrors may be moveable towards and away from the central axis, in order to alter the size of the aperture.

The planar mirrors may be arranged such that the angle of the planar mirrors to the central axis is unchanged as the planar mirrors move towards and away from the central axis.

The reflector may include means for moving the planar mirrors towards and away from the central axis.

The moving means may be remotely actuable, to control operation of the moving means from outside a chamber receiving the reflector, wherein the chamber is held under vacuum whilst the size of the aperture is changed.

The moving means may include a chassis, and a mount for each mirror, the means for moving the planar mirrors being arranged such that the planar mirrors move relative to the chassis.

The chassis may comprise a first part, and a second part rotatable relative to the first part, wherein rotation of the first part relative to the second part is translated to linear movement of the planar mirrors towards or away from the central axis.

According to a second aspect of the invention, there is provided an apparatus for cooling and/or trapping atoms or molecules including: a reflector according to the first aspect.

The apparatus may also include an atom or molecule source.

The apparatus may also include means for generating a magnetic field, the magnetic field varying spatially across the cooling region, and having one or more points where the field is zero within the cooling region, such that the apparatus is a magneto-optical trap.

The apparatus may also including a housing defining a volume enclosing at least the atom or molecule source and the reflector, and arranged to hold the volume under high vacuum.

According to a third aspect of the invention, there is provided a mirror for forming the reflector of the first aspect.

According to a fourth aspect of the invention, there is provided an apparatus for providing a focussed beam of cooled atoms or molecules, comprising: a trap including: a reflector according to the first aspect; an atom or molecule source; and means for generating a magnetic field, the magnetic field varying spatially across the cooling region of the reflector, and having one or more points where the field is zero within the volume; and a focussing apparatus including a reflector according to the first embodiment, wherein the trap produces a beam of cooled atoms or molecules from the atom or molecule source, and the focussing apparatus focuses the beam. The focussing apparatus does not include a magnetic field having one or more points where the field is zero within the cooling region of the reflector.

It will be appreciated that optional features discussed in relation to any of the above aspects may also be applied to the other aspects.

Embodiments of the invention will now be described, by way of example only, with reference to the accompanying drawings, in which:

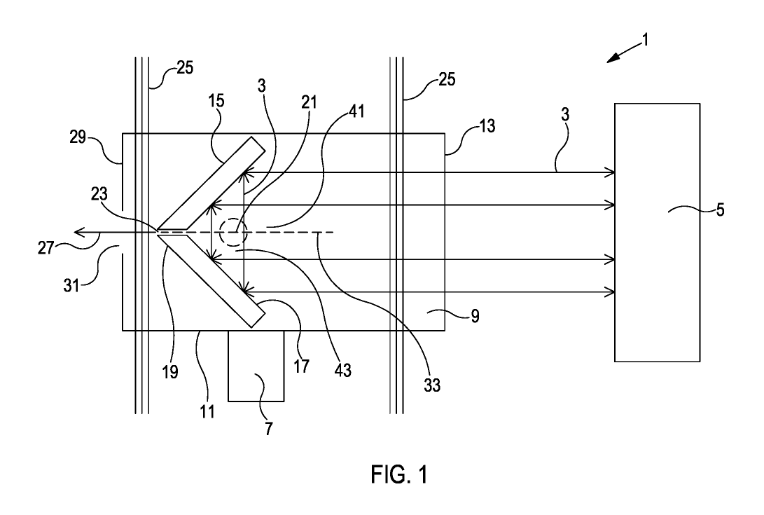

FIG. 1 schematically illustrates a source of a beam of cold atoms including a magneto-optical trap;

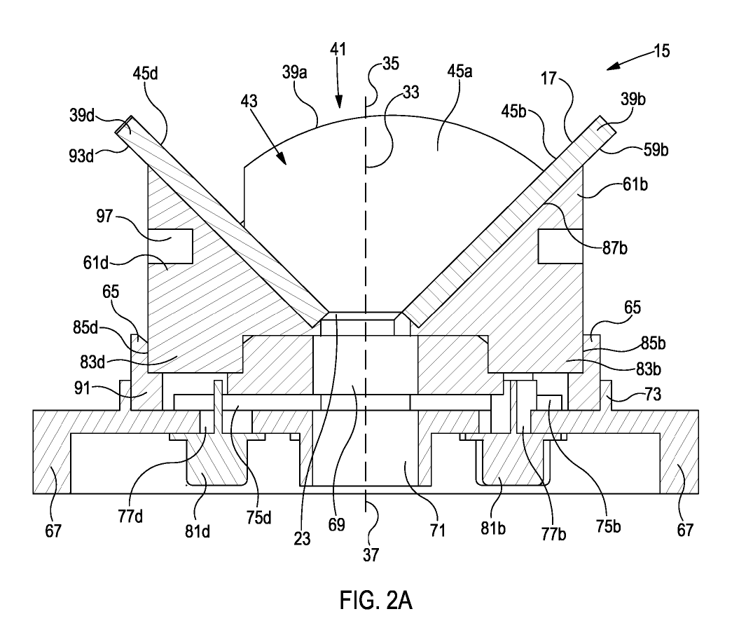

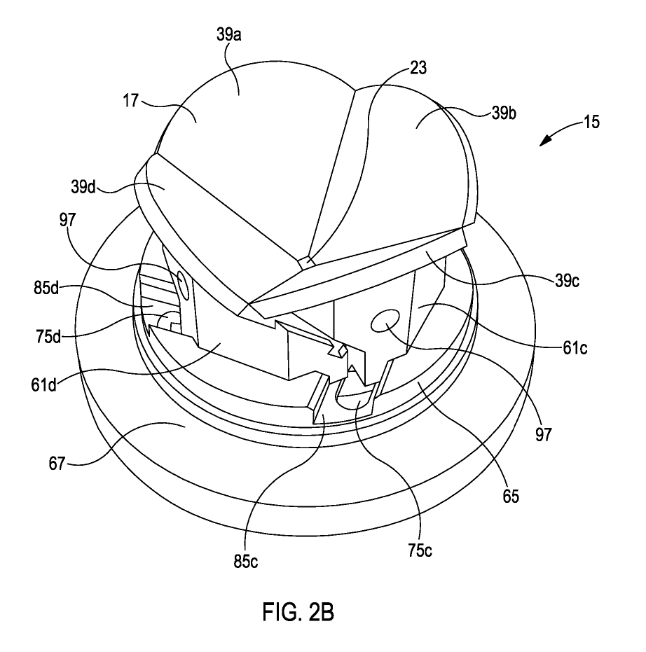

FIG. 2A illustrates a cut-through side view of a reflector for the magneto-optical trap of FIG. 1;

FIG. 2B illustrates a perspective view of the reflector of FIG. 2A;

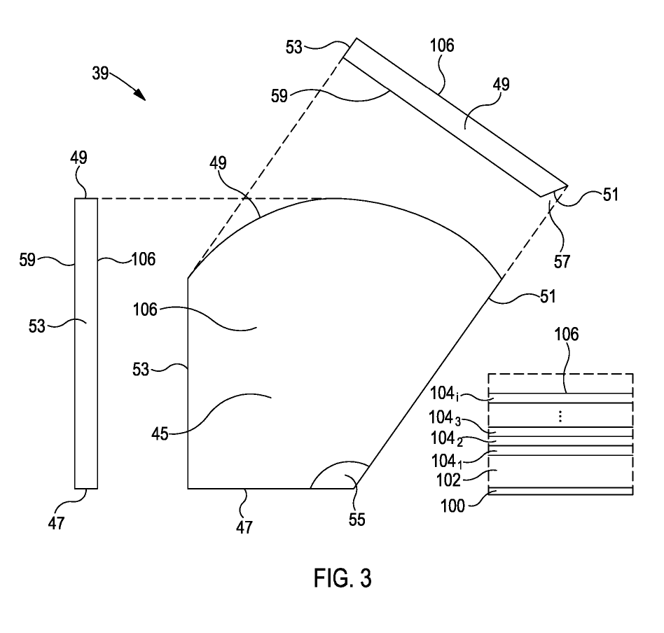

FIG. 3 illustrates a planar mirror from the reflector of FIGS. 2A and 2B;

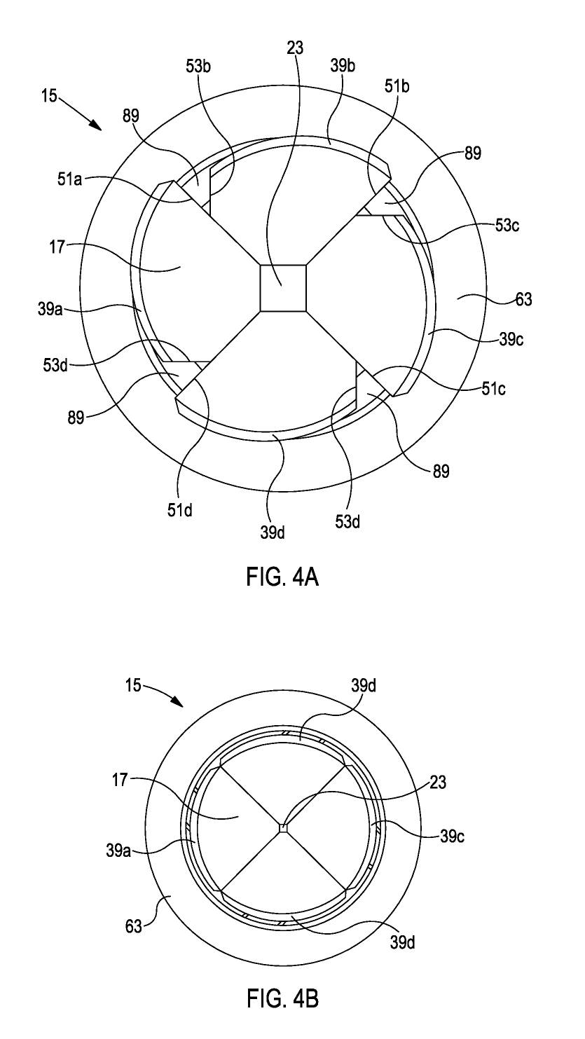

FIG. 4A illustrates a plan view of the reflector of FIGS. 2A and 2B, with a first size aperture;

FIG. 4B illustrates a plan view of the reflector of FIGS. 2A and 2B, with a second size aperture; and

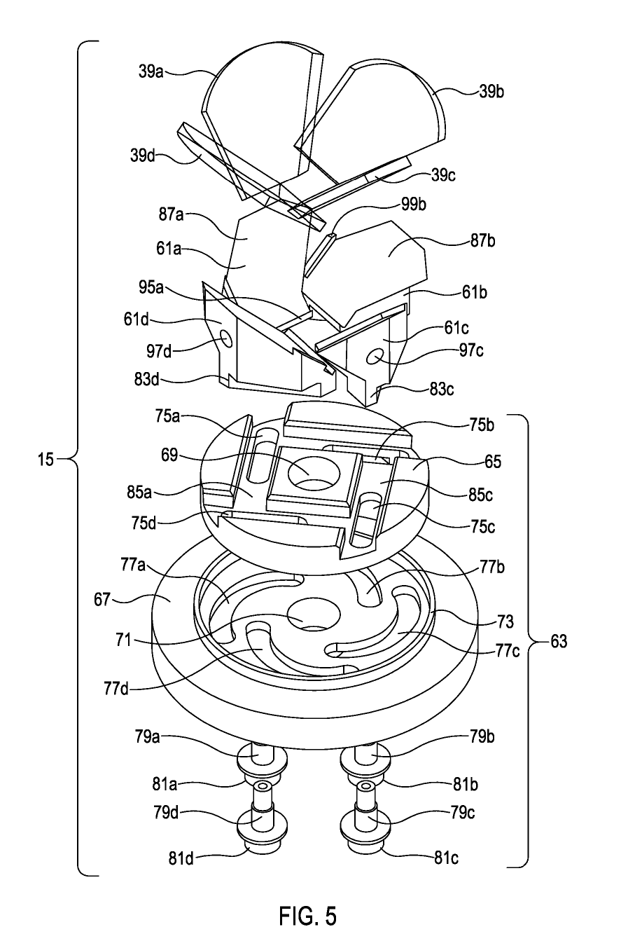

FIG. 5 illustrates an exploded view of the reflector of FIGS. 2A and 2B.

FIG. 1 schematically illustrates a magneto-optical trap 1. The magneto-optical trap 1 uses light 3 from a laser source 5 to slow (cool) and trap atoms, in a magnetic field.

The magneto-optical trap 1 is formed in a chamber 9, which is defined by a housing 11, and held under high vacuum.

Within the chamber 9 a reflector 15 is provided. The reflector 15 has a reflective inner surface 17. The reflective inner surface 17 is arranged around the chamber 9, facing inwards, and extends along a portion of the length of the chamber 9. The reflective surface 17 narrows away from a first end 13 of the housing 11, so that it is pyramidal in shape. An opening 41 is formed facing the first end 13 of the housing 11, to admit the light 3 from the laser source 5. Magnetic coils 25 are also provided around the housing 11, either side of the reflector 15 along the length of the chamber 9. The magnetic coils 25 are co-axial and have opposing currents, so that they form a field that varies spatially over the reflector 15, and which is zero at the mid-point on the line extending between the centres of the coils 25.

The laser source 5 is directed towards the first end 13 of the housing 11. The light 3 emitted by the laser source 5 is linearly polarised. In order to trap atoms, the light 3 must be circularly polarised. Therefore, the light is passed through a quarter wave plate before reaching the reflector 15 (inside or outside the chamber 9).

The first end 13 of the housing 11 transmits the light 3 emitted by the laser source 5. The light 3 is then reflected by the reflecting surface 17, to provide further beams 3 travelling perpendicular to the input beam 3 and in the opposite direction to the input beam 3. Atoms are provided into the chamber 9 by an atom source 7, connected to, or in, the chamber 9. The laser beams 3 create forces acting on the atoms. Therefore, an atom trapping region 21 is formed within the volume 43 defined by the reflecting surface 17 where the magnetic field generated by the coils 25 is zero. Outside the trapping region 21, the force acts to cool the atoms.

An aperture 23 is provided at the apex of the reflector 15, facing the second end 29 of the housing 11. Laser light 3 in the input direction applies a force to the cooled trapped atoms, forming a beam 27 of cool atoms passing through the aperture 23. The second end 29 of the housing 11 includes an aperture 31 through which the beam 27 of cooled atoms may pass, to be provided for further use.

To ensure the chamber 9 remains under high vacuum, the second end 29 of the housing 11 can be sealed by a cap (not shown), or can be sealingly joined to a further chamber held under high vacuum (not shown).

FIGS. 2A and 2B show an example of the reflector 15 in more detail. FIG. 2A shows the assembled reflector 15 in cut-through side view. FIG. 2B shows the assembled reflector 15 in perspective view.

The reflector 15 is arranged around and along a central axis 33. Along the axis 33, the reflector 15 extends from a first end 35 to a second end 37. In the chamber 9, the central axis 33 of the reflector 15 runs through the chamber 9, parallel to the input direction of the laser light 3.

The reflective surface 17 has four flat reflective faces 45a-d arranged around the central axis, directed inwards towards the central axis 33. In a plane perpendicular to the central axis 33, each face 45a-d is perpendicular to the adjacent faces 45a-d.

The faces are arranged at an angle of approximately 45° to the central axis, so that the reflecting surface 17 converges inwards from the first end 35 towards the second end 37, forming the pyramidal shape discussed above. The pyramid is truncated in shape, by removing the apex of the pyramid, to form the aperture 23 facing the second end 29 of the housing 11.

The reflecting surface is formed by four separate mirrors 39a-d, each forming one of the flat faces 45a-d of the reflecting surface 17. The mirrors 39a-d are formed from flat sheets, and so can be considered planar. The mirrors 39a-d are mounted at the desired angle to the central axis 33. The mounting of the mirrors 39a-d will be discussed in more detail below.

The four mirrors 39a-d are identical in shape and construction, which makes manufacture of the mirrors 39a-d simple. FIG. 3 shows the plan and side views of one of the mirrors 39 in more detail. The mirrors 39 are formed of a layered structure, as shown by the insert of FIG. 3, which shows a cut through taken perpendicular to the front face 106 of the mirror 39.

The mirror 39 includes a supporting layer 100, typically of a metal such as stainless steel. A glass layer 102 (for example BK7) is provided on the supporting layer 100. The glass layer 102 is secured to the supporting layer 100 by a high vacuum compatible adhesive. The glass layer 102, is coated with a number of dielectric coating layers 104₁-104ᵢ, to form a highly reflective surface. Each dielectric layer 104 is roughly λ/4n thick, where λ is the wavelength of the laser light 3 in the dielectric material and n is the refractive index of the material of the layer 104. The thickness ensures constructive interference of construction of reflections from different layers.

The number of layers (i) is chosen to ensure a suitable portion of the laser light 3 is reflected. Ideally, as close as possible to 100% of s- and p-polarised light should be reflected, with equal phase shifts for both polarizations. The top most layer 104ᵢ forms the front face 106 of the mirror 39. Typically, i≈21, however, any suitable number of layers could be used.

In plan view, the planar mirror 39 has a curved edge 49 at one end. At the opposite end, the mirror 39 has a straight edge 47.

A first side 51 of the mirror 39 extends between a first end of the curved edge 49 and a first end of the straight edge 47. The first side 51 extends obliquely to the straight end 47, at an obtuse angle 55, and is formed with a chamfer 57, such that the reflecting face 45 of the mirror 39 is wider than the opposing rear face 59. This side is referred to as the angled side 51.

A second side 53 of the mirror 39, opposite the first side 51, extends between a second end of the curved edge 49 and a second end of the straight edge 47. The second side 53 extends at 90° to the straight end 47. This side is referred to as the straight side 53.

As can be seen from FIG. 3, the mirror 39 is formed from a portion of a circle, defined by the curved edge 49. In the example shown, the radius of the curve 49 is such that centre of the circle is formed on the face of the mirror 39. However, it will be appreciated that any suitable radius curve could be used, and the centre of the circle may be off the region of the mirror 39.

Since the mirror 39 is formed by a portion of a circle, it can be made by manufacturing a circular mirror, and then cutting the desired shape from the circular mirror. One or more mirrors 39a-d may be cut from the same circle. It will be appreciated that the dielectric coating 104 may be deposited onto the glass layer 102 either before or after the cutting.

In use, the mirrors 39a-d are positioned so that the curved edge 49a-d of each mirror 39a-d forms a part of the opening 41, and the straight edge 47a-d of each mirror 39a-d forms an edge of the aperture 23. Therefore, the curved edges 49a-d of the four mirrors 39a-d together form a large perimeter around the central axis 33, and the straight edges 47a-d of the four mirrors 39a-d together form a short perimeter around the central axis 33.

The mirrors 39a-d are arranged to overlap one another. This is best illustrated in FIG. 4A, which shows a view of the reflecting surface 17 from the first end 35 of the reflector 15. Each mirror 39a-d is arranged so that a first portion of each mirror 39a-d, formed at the angled side 51a-d of the mirror 39a-d, sits over a second portion of the adjacent mirror 39a-d in the clockwise direction, the second portion formed at the straight side 53a-d of the mirror 39a-d. The aperture 23 is formed by at least a portion of the straight end 47a-d, and the first and second portion of the mirrors 39a-d may be formed over part or all of the length of the edges 51a-d, 53a-d, depending on the amount of overlap.

The overlapping of the mirrors 39a-d ensures that a continuous reflecting surface 17 is formed, without regions where laser light 3 is not reflected, near the trapping region 21. Regions where the reflecting surface 17 is not continuous would reduce the area over which atoms are trapped. The chamfer 57a-d on the overlapping edge of the mirror 39a-d also helps to improve the overlap where the mirrors 39a-d meet, creates a regular shape aperture 23, and reduces the number of cut edges presented to the laser beam 3. Cut edges can cause scattering of the beam 3, reducing the ability of the laser beam 3 to cool atoms.

In the assembled reflector 15, each mirror 39a-d is supported on a respective mount 61a-d. Each mount 61a-d has a flat face 87a-d arranged at 45° to the central axis 33. The flat face 87a-d of the mount 61a-d may form the supporting layer 100 of the mirror 39a-d, or a separate supporting layer 100 may be used. Where a separate supporting layer 100 is used, a high vacuum compatible adhesive may be used to fix the supporting layer 100 to the mount 61a-d.

The front face 87a-d of the mount 61a-d is smaller than the mirror 39a-d in length and width. Therefore, the curved edge 49 a-d and angled side 51a-d of the mirror 39a-d overhang 93a-d the mount 61a-d. When fixing the mirrors 39a-d to the mounts 61a-d, the overhang 93a-d ensures that any adhesive that leaks out does not interfere with the working of the reflector 15. Furthermore, the overhang 93a-d at the curved edge 49a-d provides a space around the outside of the reflector 15 that can be used to accommodate wires, and other devices, without increasing its radial footprint, thereby keeping it compact.

At the bottom edge of the front face 87a-d of the mount 61a-d, a lip 95a-d is provided, along the straight edge of the mount 61a-d. A lip 99a-d is also provided down a portion of one side of the front face 87a-d. The lips 95a-d, 99a-d are used to accurately and simply locate the mirrors 39a-d on the mounts 61a-d.

The mirrors 39a-d can be manufactured in situ on the mounts 61a-d, or can be manufactured separately and then fixed to the mounts 61a-d. When the mirrors 39a-d are manufactured in situ, the glass layer 102 (or glass layer 102 and separate support layer 100) is secured to the mount 61a-d, and then the dielectric layers 104 are deposited. The mounts 61a-d include openings 97 perpendicular to the central axis 33. The openings 97 allow the mounts 61a-d to be supported during in situ manufacture, or mounting or prefabricated mirrors 39a-d.

The mounts 61a-d are, in turn, secured to a chassis 63, which is mounted in the chamber 9. FIG. 5 shows an exploded view of the reflector 15.

The chassis 63 includes a first annular disc 65, and a second annular disc 67. Both discs 65, 67 include a central aperture 69, 71, that aligns with the aperture 23 formed in the reflecting surface 17, to allow emission of the beam 27 of cold atoms.

The second annular disc 67 has an annular lip 73 projecting upwards, spaced from the edge of the disc 67. The first annular disc 65 is sized to fit within, and be retained by, the annular lip 73, on top of the second annular disc 67. Once fitted within the lip 73, the first annular disc 65 is able to rotate relative to the second annular disc 67. The first annular disc 65 includes a downward projecting lip 91 at is edge. The downward projecting lip 91 is the only part of the first disc 65 than sits on the second disc 67, preventing air being trapped between two large contacting surfaces.

The first annular disc 65 includes four straight guides 75a-d, formed as elongate openings through the first annular disc 65. The second annular disc 67 includes four curved guides 77a-d, formed as elongate openings in the second disc 67.

The straight guides 75a-d are offset from the central axis 33, and extend perpendicular to the direction in which they are offset. A first end of each guide 75a-d is approximately in line with the central axis 33 in the direction of the offset, and all the guides extend towards the edge of the disc 65 in a clockwise direction.

The curved guides 75a-d are formed of an arc, which curves around the second disc 67, and gradually gets closer to the central axis 33 as it extends clockwise. Each curved guide 77a-d is the same distance from the central axis 33. Taken along a radius from the central axis 33, the end of each curved guide 77a-d that is furthest from the central axis 33 aligns with the end of the adjacent guide 77a-d that is closest to the central axis 33.

In use, each mount 61a-d is secured to the chassis 63 by a joining member 79a-d. The joining member 79a-d passes through, but is free to move through, a respective straight guide 75a-d, and a respective curved guide 77a-d, and is then connected to the mount 61a-d by a screw thread (not shown) on the top of the joining member 79a-d interacting with a screw thread (not shown) formed in the mount 61a-d. The joining members 79a-d have an enlarged end 81a-d, so that they are retained.

The mounts 61a-d are also retained relative to the chassis 63 by projections 83a-d on the bases of the mounts 61a-d engaging in recesses 85a-d in the first annular disc 65, formed around the straight guides 75a-d. Furthermore, the top sides of the recesses 85a-d are chamfered, to provide channels to allow air to escape and not be trapped between the mounts 61a-d and the first disc 65, improving the pumping down speed.

In use, the annular discs 65, 67 are free to rotate relative to each other. Relative rotation of the annular discs 65, 67, causes movement of the joining members 79a-d through the straight guides 75a-d, meaning that the rotational movement is translated to movement of the joining members 79a-d and hence the mounts 61a-d to which they are connected. The arrangement of the curved guides 77a-d, which controls the movement in the straight guides 75a-d, means that rotational movement of the discs 65, 67 translates to movement of the mounts 61a-d (and mirrors 39) towards or away from the central axis 33, depending on the direction of rotation.

The rotational symmetry of the discs 65, 67 means that all the mounts 61a-d are moved the same amount, so the aperture 23 formed by the mirrors 39a-d remains square, rather than rectangular, and the mirrors 39a-d do not collide with each other. Movement of the first disc 65 clockwise with respect to the second disc 75a-d causes the mounts 61a-d to move towards the central axis 33, closing the aperture 23. Similarly movement of the first disc 65 anti-clockwise with respect to the second disc 75a-d causes the mounts 61a-d to move away from the central axis 33, opening the aperture 23. As the mounts 61a-d move, the mirrors 39a-d move past each other. The chamfer 57a-d reduces the risk of a mirror 39a-d scratching the mirror 39a-d it passes over.

In the plane of the aperture 23, the joining members 79a-d are fixed to the mounts 61a-d at the centre of mass of the mirror 39a-d and mount 61a-d. This means that rotational motion of the mirrors 39a-d is minimised when the annular discs 65, 67 are rotated to move the mirrors 39a-d, thereby minimising friction.

The aperture 23 may be varied to have sides of any size below the length of the straight edge 47a-d. For example, the maximum size may be 5 mm across, 1 cm across, or more or less. However, the maximum size can be limited to be smaller than the length of the straight edge 47a-d by the length of the straight guides 75a-d, and length and curve on the curved guides 77a-d. The length and curve on the curved guides 77a-d and the length of the straight guides 75a-d also limits how small the aperture can be made. For example, the aperture may be closed to a minimum size, having sides of 0.5 mm. FIGS. 4A and 4B shows the aperture 23 with two different sizes.

It will be appreciated that the angle of the planar mirrors 39a-d does not change as they are moved. Therefore, opening and closing the aperture 23 will also open and close the opening 41 at the first end 35 of the reflector 15.

It will also be appreciated that as the aperture 23 opens, the first portion of each mirror 39a-d (which overlies the adjacent mirror 39a-d at the angled side 51a-d) and second portion of each mirror 39a-d (which underlies the adjacent mirror 39a-d at the straight side 53a-d) reduce in size, and the overall areas of the mirrors 39a-d that is exposed to laser light 3 increase. However, a gap 89 can form between adjacent mirrors 39a-d, near the curved edge 49a-d. Whilst this gap 89 does create areas where laser light 3 is not reflected, the effect is minimal, since it is at the wider end of the reflecting surface 17. The gap 89 also means that the larger perimeter formed at the opening is formed by part of the sides 51a-d, 53a-d of the mirrors 39a-d as well as the curved edges 49a-d.

In one example, manual rotation of the discs 65, 67 may be used to open and close the aperture 23. In other examples, a motor (not shown), or other automation may be provided. The motor may be controlled local, or remotely, so that the size of the aperture 23 can be controlled from outside the housing 11, so that the vacuum does not need to be broken to change the size of the aperture 23. In some examples, opening the aperture 23 whilst pumping down to high vacuum may speed up the pumping process, or in other examples the aperture 23 may be closed to stop the flow of atomic vapour into a separate higher vacuum region.

Typically the housing 11 is cylindrical. The second disc 67 is sized to form a tight fit with the inside housing 11, for simple and compact mounting of the reflector 15 in the chamber 9. The mirrors 39a-d are sized so that the opening 41 of the reflecting surface 17 is as wide as possible within the space allowed, to capture as much light 3 and as many atoms as possible.

Housings 11 for forming a chamber 9 under high vacuum are known in the art, and are typically provided in standard sizes. Therefore, second disc 67 may be sized to fit into one of the standard sizes. Different reflectors 15 (and/or first discs 65 and/or second discs 67) may be provided for different standard size housings 11.

In the above example, the beam 27 is provided through the aperture 31 in the housing 11 for further use. However, it will be appreciated that where the further use does not require higher vacuum than the cooling and trapping, the further use may be in the same chamber 9. Alternatively, where the second disc 67 forms a sufficiently tight fit, the chamber may be divided into two, so that the part of the chamber between the reflector 15 and the second end 29 can be under higher or lower vacuum than the opposite end, as required.

As discussed above, the first end 13 of the housing 11 transmits the laser light 3. In some cases, the whole end 13 may be transparent (e.g. a glass plate fixed to a cylindrical housing 11). Alternatively, a window may be provided in an end formed of the same material as the cylindrical housing 11. Furthermore, the first end 13 of the housing 11 may only transmit a portion of the laser light 3, for example, the first end 13 may only transmit 5%, 10%, or more of the laser light 3, up to 100% transmission.

Furthermore, in the above example, the laser beam 3 passes directly from the first end 13 of the housing 11 to the reflector 15. It will be appreciated that in some cases, this path may not be direct, and the beam 3 may be directed by mirrors (not shown).

At low pressures such as in high vacuum, certain materials can start to release gaseous impurities (outgas). The impurities could mix with the cold atoms. To ensure no impurities are released, any material used within the chamber 9, including the layers 100, 102, 104 of the mirrors 39a-d should be selected to be stable for use at low pressure. Certain stainless steels (such as 300 series austenitic stainless steels) and aluminium are typically suitable.

At least the surfaces of any moving part that moves over another part may include a low friction material. In some examples, the body of the components of the chassis 63 may be made from aluminium or stainless steel, with the surfaces that move over each other made from the low friction material. In other examples, the whole of one or more of the components may be made from the low friction material.

Examples of low frictional materials that do not outgas are phosphor bronze, beryllium copper, polytetrafluoroethylene (PTFE) and polyether ether ketone (PEEK). These materials could be used instead of or with stainless steel or aluminium.

Instead of or as well as using low friction materials, moving parts may be lubricated with high vacuum compatible lubricants, such as molybdenum disulphide.

It will be appreciated that any suitable atom source 7 may be used. In one example, the atom source is a wire or strip of a compound including the atoms to be cooled, and a getter material. A current is applied to the wire or strip causing it to heat up. Pure atoms of the material to be cooled are released, along with other gasses. The other gasses are absorbed by the getter material. In one example the wire or strip may be rubidium chromate, and rubidium atoms may be released.

Other vapour sources can also be used. Another example of a vapour source has a tube containing a sample of the atom to be cooled, which is heated (or cooled) to give the required vapour pressure of atoms.

The source 7 may provide any suitable atoms for cooling and trapping. In some examples, the reflector 15 may be used to trap caesium, rubidium and potassium, which have substantial vapour pressure close to room temperature. However, in other examples, the atoms could be other alkali metals, such as sodium or lithium, or could be non-alkalis such as calcium or ytterbium.

The wavelength of laser light 3 required varies depending on the atom to be cooled. Table 1 provides the required wavelength for some commonly used isotopes. In order to cool atoms, laser light 3 at two or more different frequencies is required. The difference between the frequencies is very small (typically a few gigahertz) compared to the absolute frequencies required (typically hundreds of terahertz). Table 1 gives the wavelength of the absolute frequencies. The laser beams 3 discussed above may include beams of the different required frequencies.

TABLE 1
laser wavelengths required to trap some commonly used atoms.

| Atoms | Laser Wavelength (nm) |
|---|---|
| Rubidium-87 | 780 |
| Caesium | 852 |
| Potassium-39 | 767 |
| Sodium | 589 |
| Lithium | 671 |
| Calcium-40 | 422 |
| Ytterbium | 399 |

In order to generate the required frequencies, the laser source 5 may include a laser to generate a single beam at a single frequency, and then a frequency modulator to generate the required frequencies. Alternatively, the laser source 5 may include multiple lasers.

Although the width of the dielectric layers 104 of the mirror is chosen depending on the wavelength of light required, the mirrors 39a-d have broadband operation, and therefore the same mirrors 39a-d may be used for a number of different atoms. For example one set of mirrors 39a-d may reflect any light in the near-infrared region (wavelengths of 700 nm or greater), while other sets of mirrors may have operation at lower wavelengths. For example, the above range of wavelengths may be covered by three sets of mirrors 39a-d (a first set for reflecting wavelengths of less than 500 nm, a second set for reflecting wavelengths between 500 nm and 700 nm, and the third set for reflecting wavelengths longer than 700 nm).

The mirrors 39a-d may be swapped by using interchangeable mirrors 39a-d or interchangeable mounts 61a-d, or there may be different reflectors 15 for each wavelength range.

The size, location and shape of the trapping region 21 will depend on the magnetic field. It will be appreciated that the trapping region 21 shown in FIG. 1 is shown for illustrative purposes only. In reality, the trapping region may be formed with any shape and size, and in any position inside the volume 43 defined by the reflecting surface 17.

In the construction of the mirrors 39a-d discussed above, the glass layer is BK7 glass. In other examples, the glass layer 102 may be UV fused silica, or any other suitable glass. When using glasses transparent to UV, it allows UV curing of adhesive when fixing the mirror (or just the glass layer) to the mount 61a-d. This can speed up the manufacturing process. Furthermore, there may be any number of dielectric layers 104, and any suitable dielectric may be used.

In the above, the glass layer 102 or support layer 100 is secured to the mount 61a-d by a high vacuum compatible adhesive. However, any other suitable method may be used, such as screw fixings, clamps, indium metal, vacuum compatible solder, anodic bonding and the like.

It will also be appreciated that the example construction of the mirrors 39a-d discussed above is given by way of example only. Any mirror 39a-d that has a highly reflective surface that reflects the laser light 3, and which is made from stable materials that do not outgas could be used.

In other examples, the glass layer 102 may be omitted, and a polished metal (stainless steel or aluminium) surface used instead. The polished metal layer may either be the mount 61a-d (such that the dielectric layers 104 are deposited onto the surface of the mount 61a-d), or a separate supporting layer 100.

The shape of the mirrors 39a-d is also given by way of example only. Any suitable shape, with or without a curved edge 49a-d may be used. For example, the angle 55a-d of the angled side 51a-d may be changed, and may also be 90° or any other obtuse or acute angle. Similarly, the straight side 53a-d may be changed so that it extends obliquely with respect to the straight edge 47a-d.

The straight edge 47a-d is also optional. The use of the straight edge ensures that the mirrors 39a-d do not meet at an apex, and so the aperture 23 is formed is of regular shape. Nonetheless, mirrors 39a-d with different shapes at the edge 47a-d that forms the aperture 23 may be used. For example, the mirror may end in a point, or have an edge of a different shape.

In some case, both sides 51a-d, 53a-d of the mirror 39a-d may be chamfered. The edges 47a-d, 49a-d may also be chamfered. Providing a chamfer on the top curved edge 49a-d of the mirror 39a-d, in a direction parallel to the central axis 33, helps to reduce the radial footprint of the reflector 15. In this way, the reflecting surface 17 can be made so that when the aperture is at the maximum size, the mirrors 39a-d are the same size or smaller than the second annular disc 67. Alternatively, there may be no chamfer.

Also, the construction of the reflecting surface 17 discussed above is also given by way of example only. In the above example, the reflecting surface 17 is formed of four separate planar mirrors 39a-d. However, instead of four planar mirrors 39a-d, the reflecting surface could be formed by three planar mirrors 39, or five or more planar mirrors 39a-d.

With any number of mirrors 39a-d (three or more), the mirrors 39a-d are arranged around the central axis 33, and at an angle to the central axis 33, so they converge along the axis 33 towards the second end 37. In this way, the reflecting surface 17 can be seen as forming an n-sided pyramid. For example, for n=3, the pyramid is a triangular pyramid, for n=4 a square pyramid.

It will also be appreciated that the overlapping arrangement discussed above is by way of example only. In other examples, the mirrors 39a-d may overlap in different ways.

For example, in an arrangement of four mirrors 39a-d, arranged around the central axis 33 as discussed in relation to FIGS. 2A, 2B, 3, 4 and 5, the first mirror 39a may overlap the second mirror 39b on one side and the fourth mirror 39d on the other. Similarly, the third mirror 39c may overlap the fourth mirror 39d on one side, and the second mirror 39b on the other.

Other arrangements of mirrors 39a-d overlapping will be readily apparent for any number of mirrors 39a-d.

In the above description, the mirrors 39a-d are arranged at 45° to the central axis 33. This angle is given by way of example only, and any suitable angle which provides the necessary reflections to cool and trap atoms may be used. For different numbers of mirrors 39a-d, the angle may change, or may still be 45°.

In the above, each face 45a-d of the reflecting surface 17 is formed of a single mirror 39a-d. However, in other examples, each face 45a-d may be made of more than one mirror 39a-d, and the split between the mirrors 39a-d may be parallel to the central axis 33, perpendicular to the central axis 33, or along any other dividing line.

The mounts 61a-d and chassis 63 discussed above are also given by way of example only. Any suitable means may be used to support the mirrors 39, and to move the mirrors towards or away from the central axis 33, closing and opening the aperture 23.

In all the above examples, the curved guides 77a-d and straight guides 75a-d extend clockwise. However, the guides 75a-d, 77a-d may extend in the opposite direction. Furthermore, the guides 75a-d, 77a-d formed in the discs 65, 67 of the chassis 63 may have any suitable shape and arrangement. Furthermore, the ends of the curved guides 77a-d do not necessarily align as discussed above.

It will also be appreciated that the lips 95a-d, 99a-d are just given as one example of a possible way to accurately locate the mirrors 39a-d. Any suitable means for locating the mirrors may be used, or the means may be omitted altogether, and the mirrors fixed in place under a microscope or the like.

The upward facing lip 73 on the second annular disc 67, and/or the downward facing lip 91 on the first annular disc 65 may be omitted.

In the above example, the joining member 79a-d is joined to the mount 61a-d by inter-engaging screw thread, and retained in the chassis by an enlarged end. It will be appreciated that this is by way of example only. In other examples, the joining member 79a-d may be fixed to the mount 61a-d using a push fit, or other type of connection. Alternatively, the joining member 79a-d may be formed integrally with the mount 61a-d, and the joining member may be retained in the guides 75a-d, 77a-d by a nut fitted on the end of the joining member. This reduces the use of a screw thread, which can result in trapped air. In this case, the nut may be secured by high vacuum-compatible solder or adhesive.

In the above example, the curved edge 49a-d and angled edge 51a-d of the mirrors 39a-d overhang the mount 61a-d. However, it will be appreciated that this is by way of example only. The front face 87a-d of the mount 61a-d may be the same size or larger than the mirror 39a-d. Furthermore, different sides or edges may provide the overhang, and/or grooves may be provided in the surface of the mount, to accommodate excess adhesive.

In some examples, as with the examples discussed above, the means for moving the mirrors 39a-d may be arranged to convert rotational movement of the chassis 63 to translation movement of the mirrors 39a-d. In other examples, the mirrors 39a-d may be moved directly.

The aperture can be opened up to have any size below the length of the straight edge 47a-d. However, as discussed above, the mounts 61a-d, or guides 75a-d, 77a-d may be arranged to limit the maximum size of the aperture 23, so that it opens to a maximum size smaller than the straight edge 47a-d. The minimum size of the aperture 23 may be controlled in a similar manner, although, in some examples, the minimum size may have the aperture 23 fully closed.

For reflectors 15 having other than four mirrors 39a-d, and hence other than a square aperture 23, the maximum length of each side is the same as the maximum length of the square aperture 23, although this can also be limited, as discussed above.

Many of the edges on the components of the reflector 15 may be filleted, to reduce scratching and friction, although this is optional.

Any suitable laser source 5 may be used. Furthermore, in the above example the laser source 5 is outside of the high vacuum. However, in other examples, the laser source 5 may be within the high vacuum.

In the above example, the magnetic field is generated by coils 25. The coils 25 produce a magnetic field with a field of zero at a single point or region 21, (a spherical quadrupole). It will be appreciated that the same magnetic field could be produced by other types of coils, or by permanent magnets. Furthermore, instead of having a point 21 where the field is zero, the region where the field is zero extends along a line (a 2D quadrupole). In this case, the trapping region 21 would be formed along a line, rather than at a point. As with the spherical quadrupole, the 2D quadrupole can be produced by running a current through appropriately shaped and positioned coils 25 or by using permanent magnets. Therefore, any suitable means for generating the magnetic field required can be used. The means for generating the magnetic field may optionally include means to null the magnetic field of the Earth, or means for moving the region of zero magnetic field. As with the laser source 5, the means for generating the magnetic field may be inside of or outside of the high vacuum.

In the above example, a magnetic field is applied to the reflector 15. The magnetic field acts to trap the atoms in a region within the volume 43 inside the reflector 15, by creating a force that varies with position.

However, it will be appreciated that a beam of cold atoms can be generated without the field. Since the field, is omitted, the atoms will only be cooled, and not trapped. The atoms are cooled to a limit, and pushed out of the aperture 23 in the reflector 15, without being trapped. In embodiments without a trapping magnetic field applied, there may still be a field to offset the magnetic field of the Earth. This field has no trapping effect, since it does not significantly vary spatially through the volume 43 within the reflector 15, and may be omitted.

A reflector 15 without a magnetic field might have applications in atomic clocks (where it can be preferable to have a larger cloud of atoms instead of a very dense cloud) or to focus the beam 27 of cooled atoms to reduce the divergence of the beam 27. This latter possibility could involve a first reflector 15 as discussed above, with a magnetic field, to create the beam 27, and a second reflector, without a field to collimate the beam (reduce the divergence).

It will be appreciated that by making use of the reflector 15 described above, atoms may be cooled to temperatures of approximately 100 micro Kelvin. There may be a slight warming as the force exerted by the laser light pushes the atoms through aperture 23 to form a cold atomic beam 27, and the beam diverges after the aperture, but the spread of velocities in the atomic beam 27 is still small and the mean velocity is only a few, or a few tens, of metres per second.

It will be appreciated that in the above, the reflected laser beams 3 are described as travelling opposite to and perpendicular to the input direction of light 3. However, it will be appreciated that that beams 3 may not be exactly perpendicular, and may travel in any direction that forms the necessary forces to slow and cool the atoms.

Furthermore, it will be appreciated that fewer than five beams may be used to achieve cooling in some cases.

In the above, the reflector 15 is described in the context of cooling and trapping atoms. It will be appreciated that the reflector may also be used for cooling molecules.

In this case, the atom source 7 is replaced by a molecule source, and the appropriate laser source 5 should be used, in combination with mirrors 39a-d that operate at the laser frequency.

1. A reflector for cooling or trapping atoms or molecules, the reflector having a reflecting surface forming a perimeter around and facing a central axis, the reflecting surface extending along the axis, and converging from a first end of the reflector towards a second end of the reflector, such that the reflecting surface is arranged to reflect input laser light to form a cooling region,
wherein an aperture for providing a beam of cooled atoms or molecules from the cooling region is formed in the reflecting surface, the aperture perpendicular to the central axis, such that the reflector forms a truncated pyramid, and
wherein the reflecting surface is formed by three or more planar mirrors arranged around and at an angle to the central axis.

2. The reflector of claim 1, wherein each planar mirror forms a portion of the perimeter around the central axis, and wherein a first portion of a first planar mirror overlies a portion of a second planar mirror, the second planar mirror adjacent a first side of the first planar mirror.

3. The reflector of claim 2, wherein a second portion of the first planar mirror underlies a portion of a further planar mirror, the further planar mirror adjacent a second side of the first planar mirror, opposite the first side.

4. The reflector of claim 2, wherein a side of a planar mirror overlying an adjacent planar mirror is chamfered, such that the reflecting surface of the mirror is wider than an opposing rear surface.

5. The reflector of claim 1, wherein the planar mirrors are formed from a portion of a circle.

6. The reflector of claim 1, wherein the planar mirrors have a curved edge arranged to be positioned at the first end of the reflector, a straight edge, arranged to be positioned at the second end of the reflector, forming an edge of the aperture, a first side extending from a first end of the curved edge, to a first end of the straight edge, and a second side extending from a second end of the curved edge, to a second end of the straight edge.

7. The reflector of claim 6, wherein the first side may extend obliquely to the straight edge.

8. The reflector of claim 6, wherein the second side may extend perpendicularly to the straight edge.

9. The reflector of claim 1, wherein each of the planar mirrors have the same shape.

10. The reflector of claim 1, wherein the reflecting surface is formed by four planar mirrors.

11. The reflector of claim 1, wherein the planar mirrors are moveable towards and away from the central axis, in order to alter the size of the aperture.

12. The reflector of claim 11, wherein the planar mirrors are arranged such that the angle of the planar mirrors to the central axis is unchanged as the planar mirrors move towards and away from the central axis.

13. The reflector of claim 1, including means for moving the planar mirrors towards and away from the central axis.

14. The reflector of claim 13, wherein the moving means is remotely actuable, to control operation of the moving means from outside a chamber receiving the reflector, wherein the chamber is held under vacuum whilst the size of the aperture is changed.

15. The reflector of claim 14, wherein the moving means includes a chassis, and a mount for each mirror, the means for moving the planar mirrors being arranged such that the planar mirrors move relative to the chassis.

16. The reflector of claim 15, wherein the chassis comprises a first part, and a second part rotatable relative to the first part, wherein rotation of the first part relative to the second part is translated to linear movement of the planar mirrors towards or away from the central axis.

17. An apparatus for cooling or trapping atoms or molecules including: a reflector according to claim 1.

18. The apparatus of claim 17, including an atom or molecule source.

19. The apparatus of claim 17, including: means for generating a magnetic field, the magnetic field varying spatially across the cooling region, and having one or more points where the field is zero within the cooling region, such that the apparatus is a magneto-optical trap.

20. (canceled)

21. (canceled)

22. An apparatus for providing a focussed beam of cooled atoms or molecules, comprising:
a trap including:
a first reflector according to claim 1;
an atom or molecule source; and
means for generating a magnetic field, the magnetic field varying spatially across the cooling region of the reflector, and having one or more points where the field is zero within the volume; and
a focussing apparatus including:
a second reflector according to claim 1,
wherein the trap produces a beam of cooled atoms or molecules from the atom or molecule source, and the focussing apparatus focuses the beam.
